(19) United States
(12) Patent Application Publication
(10) Pub. No.: US 2015/0209974 A1
(43) Pub. Date: Jul. 30, 2015

(54) COOKIE CUTTERS WITH SHAPES ARRANGED IN A TWO-DIMENSIONAL REPETITIVE PATTERN

(71) Applicant: Irna L. Shamos, Phoenix, AZ (US)

(72) Inventor: Irna L. Shamos, Phoenix, AZ (US)

(21) Appl. No.: 14/164,219

(22) Filed: Jan. 26, 2014

(51) Int. Cl. B26F 1/44

(52) U.S. Cl. CPC B26F 1/44

(57) ABSTRACT

A cookie cutter includes a plurality of walls that are arranged to define a plurality of contiguous shapes which are arranged in a pattern that is symmetrical and that repeats defined by a first axis and a second axis, in which the first axis is perpendicular relative to the second axis.

### FIELD OF THE INVENTION

The present invention relates to cookie cutters.

### BACKGROUND OF THE INVENTION

The prior art is replete with cookie cutters, which are used to cut cookie dough into individual pieces in preparation for baking to become cookies. One type has a single shape for cutting a single piece from cookie dough. Another type has two or more shapes for simultaneously cutting two or more pieces from cookie dough.

The latter specie of cookie cutter, often referred to as a plural cookie cutter, is less common than the former. Although the prior art has provided some specific configurations of plural cookie cutters, none have proven to be entirely satisfactory. Many incorporate substantially complex and relatively expensive wall structures that form the cutting shapes. Others have open areas between the cutting shapes that produce waste in the form of left-over dough. Frequently, the prior art plural cookie cutters are inconvenient to operate, requiring that the left-over dough be re-rolled or stored for later use. Unfortunately, stored cookie dough is often neglected and ultimately thrown away. It is to be noted that the attendant waste produced from the use of the prior art cookie cutters is a long-standing and unsolved problem in the art of plural cookie cutters.

### SUMMARY OF THE INVENTION

According to the principle of the invention, a cookie cutter includes a plurality of walls arranged to define a plurality of contiguous shapes arranged in a pattern that repeats in at least two directions. In one embodiment, the shapes are similar. In another embodiment, the shapes include first shapes and second shapes. In this embodiment, the first shapes are similar, the second shapes are similar, and the first shapes are different from the second shapes. The first shapes each have a first size, the second shapes each have a second size, and the first size of each of the first shapes is larger than the second size of each of the second shapes. In a particular embodiment, the first shapes are divided, and the second shapes are arranged in divided, directly adjoining clusters.

According to the principle of the invention, a cookie cutter includes a plurality of walls arranged to define a plurality of contiguous shapes arranged in a pattern that is symmetrical and that repeats along a first axis and a second axis. The first axis is perpendicular relative to the second axis. In one embodiment, the shapes are similar. In another embodiment, the shapes include first shapes and second shapes. In this embodiment, the first shapes are similar, the second shapes are similar, and the first shapes are different from the second shapes. The first shapes each have a first size, the second shapes each have a second size, and the first size of each of the first shapes is larger than the second size of each of the second shapes. In a particular embodiment, the first shapes are divided, and the second shapes are arranged in divided, directly adjoining clusters.

### BRIEF DESCRIPTION OF THE DRAWINGS

Referring to the drawings:

FIG. 1 is an isometric view of a cookie cutter constructed and arranged in accordance with the principle of the invention, the cookie cutter shown as it would appear applied atop a sheet of cookie dough in preparation for simultaneously cutting shapes in the cookie dough in the preparation of cookies;

FIG. 2 is a top plan view of the cookie cutter of FIG. 1;

FIGS. 3-8 are top plan views of cookie cutters each constructed and arranged in accordance with the principle of the invention; and

FIG. 9 is cookie cutter roller constructed and arranged in accordance with the principle of the invention, the cookie cutter roller shown as it would appear cutting shapes in cookie dough transported by a conveyor.

### DETAILED DESCRIPTION

A plane symmetry group is a two-dimensional repetitive pattern. There are 17 possible known symmetry groups, including symmetry groups p1, p2, pm, pg, cm, pmm, pmg, pgg, cmm, p4, p4m, p4g, p3, p31m, p3m1, p6, and p6m, wherein p or c means primitive or centered cell, the number after p is the highest order of rotation (e.g., if it is 6 then there is a rotation which is ⅙ of a revolution, m is for a mirror reflection perpendicular to the x-axis, g means a glide reflection but no reflection perpendicular to the x-axis, the x-axis is the left vertical edge of a cell, 1 means no symmetry axis perpendicular to the x-axis, and the last symbol is for a symmetry axis at an angle to the x-axis. Group p1 is a parallelogram lattice made up of only translations, group p2 is a parallelogram lattice made up of both translations and rotations, group pm is a rectangle lattice made up of reflections and translations, group pg is a rectangle lattice made up of glide reflections and translations, group cm is a rhombus lattice made up of reflections and glide-reflections with parallel axes and rotations, group pmm is a rectangle lattice made up of reflections whose axes are perpendicular and half-turn rotations, group pmg has reflections and glide-reflections and translations and is a rectangle lattice, group pgg is also a rectangle lattice having glide-reflections and translations and half-turn rotations, group cmm is a rhombus lattice having reflections and 180 degree rotations, group p4 contains rotations and translations and is a square lattice, group p4m contains rotations and translations and reflections and is a square lattice, group p4g is a square lattice containing reflections and glide reflections and rotations, group p3 is a hexagon lattice made up of rotations and translations, group p31m is made up of reflections and rotations and glide reflections and is a hexagon lattice, group p3m1 is a hexagon lattice and while similar to group p31m all of the centers of rotation lie on the reflection axes, group p6 is a hexagon lattice made up of rotations and translations, and group p6m is a hexagon lattice made up of reflections, rotations, translations, and glide reflections. A repeating pattern that belongs to one of the 17 distinct symmetry groups is often referred to as a wallpaper group or a plane crystallographic group.

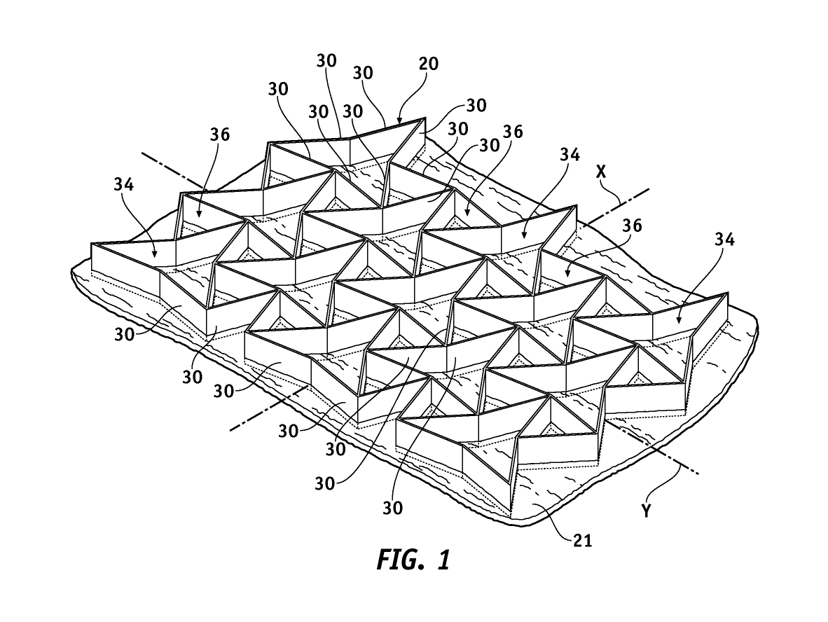

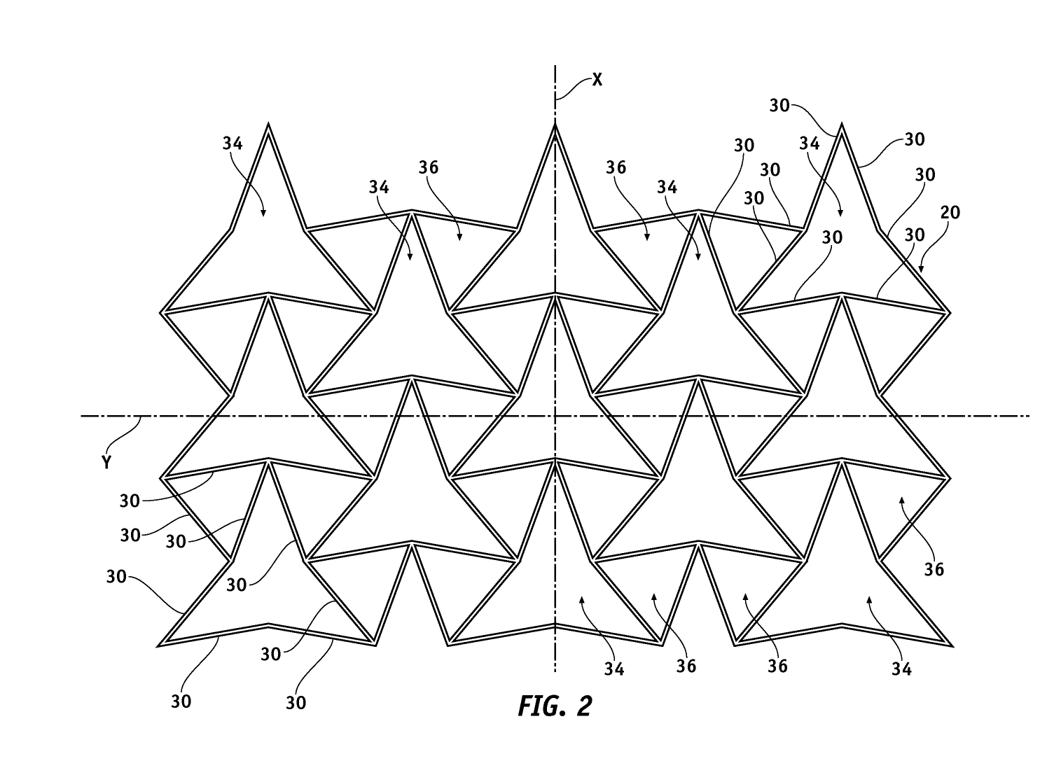

Turning now to the drawings, in which like reference characters indicate corresponding elements throughout the several views, attention is first directed to FIG. 1 in which there is seen an isometric view of a cookie cutter 20, constructed and arranged in accordance with the principle of the invention, shown as it would appear applied atop a sheet of cookie dough 21 in preparation for simultaneously cutting shapes in cookie dough 21 in the preparation of cookies. In FIGS. 1 and 2, cookie cutter 20 is a framework that includes a plurality of walls 30 arranged to define a plurality of shapes which, in this embodiment, include shapes 34 and shapes 36. As is known in the art of single cookie cutters, walls 30 of cookie cutter 20 are formed of a thin metal, such as copper or stainless steel, or thin plastic. Shapes 34 and 36 are contiguous and share two or more walls 30. Walls 30 are integrally formed, or are joined at their intersecting ends by soldering, brazing, welding, adhesives, or the like. Walls 30 have a height H denoted in FIG. 1 which may range from a fraction of an inch to over 2 or more inches, as is known in the art of single-cookie cutters. Height H of walls 30 are preferably greater than the thickness of the sheet of cookie dough 21 to facilitate the grasping of cookie cutter 20 by the baker.

Shapes 34 and 36 are arranged in a pattern that repeats in at least two directions, including direction X and direction Y. Directions X and Y are transverse relative to each other. More specifically, directions X and Y are perpendicular relative to each other. Shapes 34 are similar to one another, meaning that they are similar in shape and similar in size. The term “similar” used throughout this specification means having a likeness or a resemblance so as to be identical or at least nearly identical. Shapes 36 are also likewise similar to one another, meaning that they are similar in shape and similar in size. Shapes 34 are different from shapes 36, both in shape and in size. In other words, shapes 34 each have a shape and a size, shapes 36 each have a shape and a size, the shape of each shape 34 is different from the shape of each shape 36, and the size of each shape 34 is different from the size of each shape 36. In this embodiment, each shape 34 is that of a three-pronged star, each shape 36 is that of a triangle, and the size of each shape 34 is greater than the size of each shape 36.

In accordance with the principle of the invention, the pattern of shapes 34 and 36 is that of a plane symmetry group in the nature of a two-dimensional repetitive pattern. In other words, the pattern of shapes 34 and 36 is, according to the invention, one of the known 17 plane symmetry groups that repeats in at least two directions, including the direction of axis X and the direction of axis Y in this embodiment. Moreover, the pattern of shapes 34 and 36 repeats in either direction along axis X from a center point, and in either direction along axis Y from said center point, wherein said center point is the intersection of axis X and axis Y at the geometric center of cookie cutter 20. The pattern of shapes 34 and 36 of cookie cutter 20 is plane symmetry group p2, which is a parallelogram lattice made of translations of shapes 34 and 36 and rotations of shapes 34. In cookie cutter 20 there are thirteen shapes 34 and twenty-four shapes 36, which allows a total of thirty-seven cookies to be cut from cookie dough 21 in FIG. 1 simultaneously. The repeating pattern of shapes 34 and 36 in the directions of axes X and Y allows a cookie cutter constructed and arranged according to the principle of the invention to be fashioned with less than thirty-seven combined shapes 34 and 36 or more than thirty-seven combined shapes 34 and 36 simply by repeating the pattern of shapes 34 and 36 in the directions of axes X and Y to form a cookie cutter having the desired number of shapes for simultaneously cutting a desired number of shapes from the cookie dough.

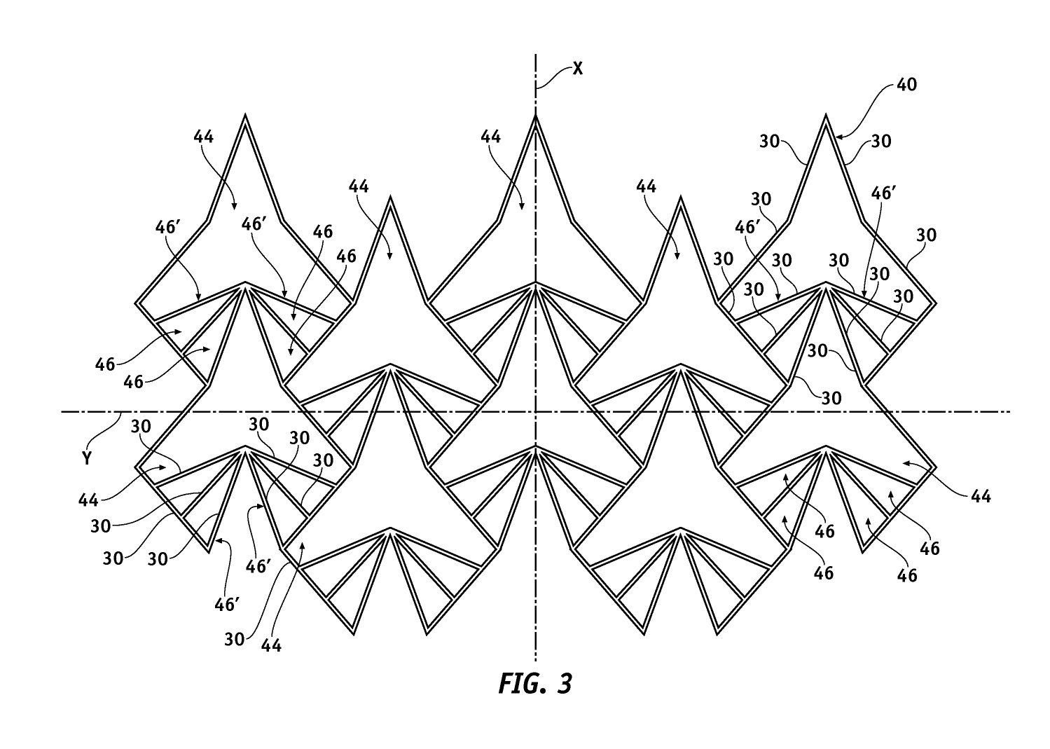

The plane symmetry pattern of shapes 34 and 36 reduces waste of cookie dough in the cutting of shapes from the cooking dough, and defines the overall dimension of cookie cutter 20. In other words, the plane symmetry pattern of shapes 34 and 36 fills the entire dimension of cookie cutter 20. This discussion applies not only to cookie cutter 20, but to each and every cookie cutter embodiment of FIGS. 3-9 discussed below.

FIG. 3 is a top plan view of an alternate embodiment of a cookie cutter 40 consisting of a framework that includes the previously-described walls 30 arranged to define a plurality of shapes, including in this embodiment shapes 44 and shapes 46. Shapes 44 and 46 are contiguous and share two or more walls 30. In this embodiment, shapes 44 and 46 are arranged in a pattern that repeats in at least two directions, including direction X and direction Y. Directions X and Y are transverse relative to each other. More specifically, directions X and Y are perpendicular relative to each other. Shapes 44 are similar to one another, meaning that they are similar to one another, meaning that they are similar in shape and similar in size. Shapes 46 are still likewise similar to one another, meaning that they are similar in shape and similar in size. Shapes 44 are different from shapes 46, both in shape and in size. In other words, shapes 44 each have a shape and a size, shapes 46 each have a shape and a size, the shape of each shape 44 is different from the shape of each shape 46, and the size of each shape 44 is different from the size of each shape 46. In this embodiment, each shape 44 is that of a three-pronged star with the ends of two of the prongs being cropped, each shape 46 is that of a triangle, and the size of each shape 44 is greater than the size of each shape 46.

In accordance with the principle of the invention, the pattern of shapes 44 and 46 is that of a plane symmetry group in the nature of a two-dimensional repetitive pattern. In other words, the pattern of shapes 44 and 46 is, according to the invention, one of the known 17 plane symmetry groups that repeats in at least two directions, including the direction of axis X and the direction of axis Y in this embodiment. Moreover, the pattern of shapes 44 and 46 repeats in either direction along axis X from a center point, and in either direction along axis Y from said center point, wherein said center point is the intersection of axis X and axis Y at the geometric center of cookie cutter 40. The pattern of shapes 44 and 46 of cookie cutter 40 is plane symmetry group p6m, which is a hexagon lattice made up of reflections of shapes 46, rotations of shapes 46, translations of shapes 44 and 46, and glide reflections of clusters of two shapes 46, wherein each cluster of two shapes 46 is denoted generally at 46′. In cookie cutter 40 there are ten shapes 44 and forty shapes 46, which allows a total of fifty cookies to be cut from cookie dough simultaneously. The repeating pattern of shapes 44 and 46 in the directions of axes X and Y allows a cookie cutter constructed and arranged according to the principle of the invention to be fashioned with less than fifty combined shapes 44 and 46 or more than fifty combined shapes 44 and 46 simply by repeating the pattern of shapes 44 and 46 in the directions of axes X and Y to form a cookie cutter having the desired number of shapes for simultaneously cutting a desired number of shapes from the cookie dough.

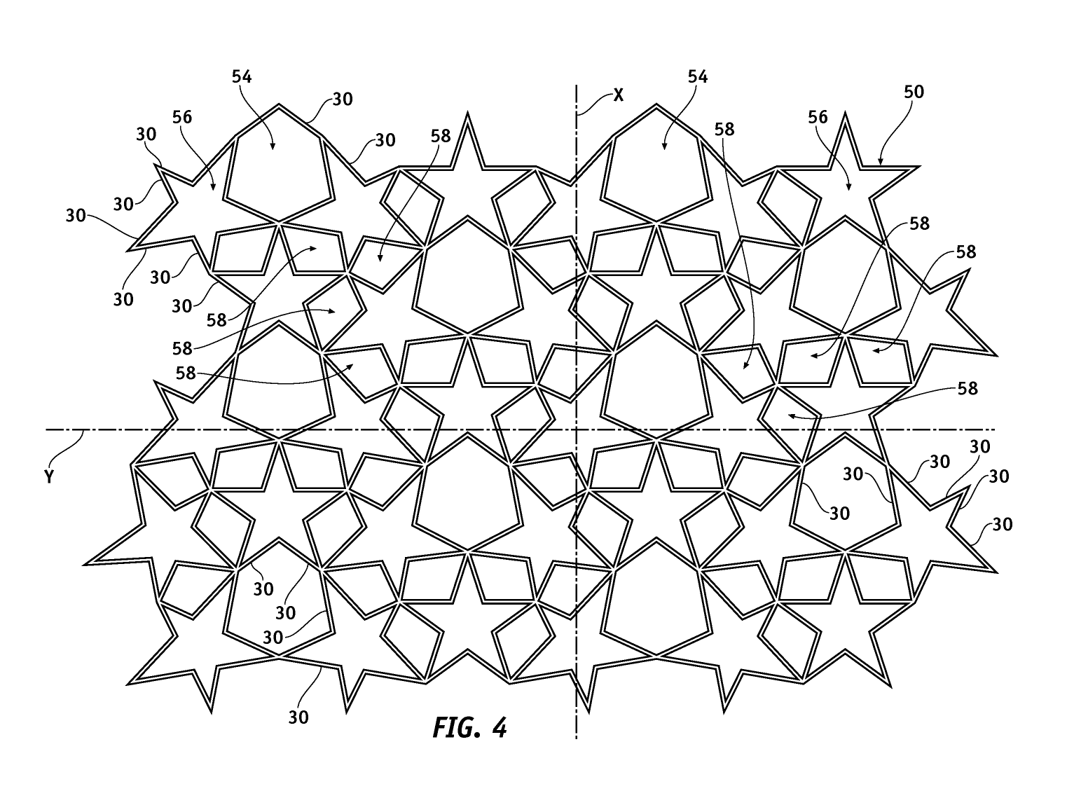

FIG. 4 is a top plan view of another alternate embodiment of a cookie cutter 50 consisting of a framework that includes the previously-described walls 30 arranged to define a plurality of shapes, including in this embodiment shapes 54, shapes 56, and shapes 58. Shapes 54, 56, and 58 are contiguous and share two or more walls 30. In this embodiment, shapes 54, 56, and 58 are arranged in a pattern that repeats in at least two directions, including direction X and direction Y. Directions X and Y are transverse relative to each other. More specifically, directions X and Y are perpendicular relative to each other. Shapes 54 are similar to one another, meaning that they are similar in shape and similar in size. Shapes 56 are likewise similar to each other, meaning that they are similar in shape and similar in size. Like shapes 54, shapes 58 are still likewise similar to one another, meaning that they are similar in shape and similar in size. Shapes 54, shapes 56, and shapes 58 are different from one another, both in shape and in size. In other words, shapes 54 each have a shape and a size, shapes 56 each have a different shape and a size, and shapes 58 each have still a different shape and a size. In this embodiment, each shape 54 is that of a distorted hexagon, each shape 56 is that of a five-pronged star, each shape 58 is that of a kite quadrilateral, and the size of each shape 54 is greater than the size of each shape 56 and each shape 58, and the size of each shape 56 is greater than the size of each shape 58.

In accordance with the principle of the invention, the pattern of shapes 54, 56, and 58 is that of a plane symmetry group in the nature of a two-dimensional repetitive pattern. In other words, the pattern of shapes 54, 56, and 58 is, according to the invention, one of the known 17 plane symmetry groups that repeats in at least two directions, including the direction of axis X and the direction of axis Y in this embodiment. Moreover, the pattern of shapes 54, 56, and 58 repeats in either direction along axis X from a center point, and in either direction along axis Y from said center point, wherein said center point is the intersection of axis X and axis Y at the geometric center of cookie cutter 50. The pattern of shapes 54, 56, and 58 of cookie cutter 50 is plane symmetry group p6m, which is a hexagon lattice made up of reflections of shapes 56 and 58, rotations of shapes 58, translations of shapes 54 and 56 and 58, and glide reflections of shapes 54 and shapes 56. In cookie cutter 50 there are ten shapes 54, thirty-one shapes 56, and forty-six shapes 58, which allows a total of eighty-seven cookies to be cut from cookie dough simultaneously. The repeating pattern of shapes 54, 56, and 58 in the directions of axes X and Y allows a cookie cutter constructed and arranged according to the principle of the invention to be fashioned with less than eighty-seven combined shapes 54, 56, and 58 or more than eighty-seven combined shapes 54, 56, and 58 simply by repeating the pattern of shapes 54, 56, and 58 in the directions of axes X and Y to form a cookie cutter having the desired number of shapes for simultaneously cutting a desired number of shapes from the cookie dough.

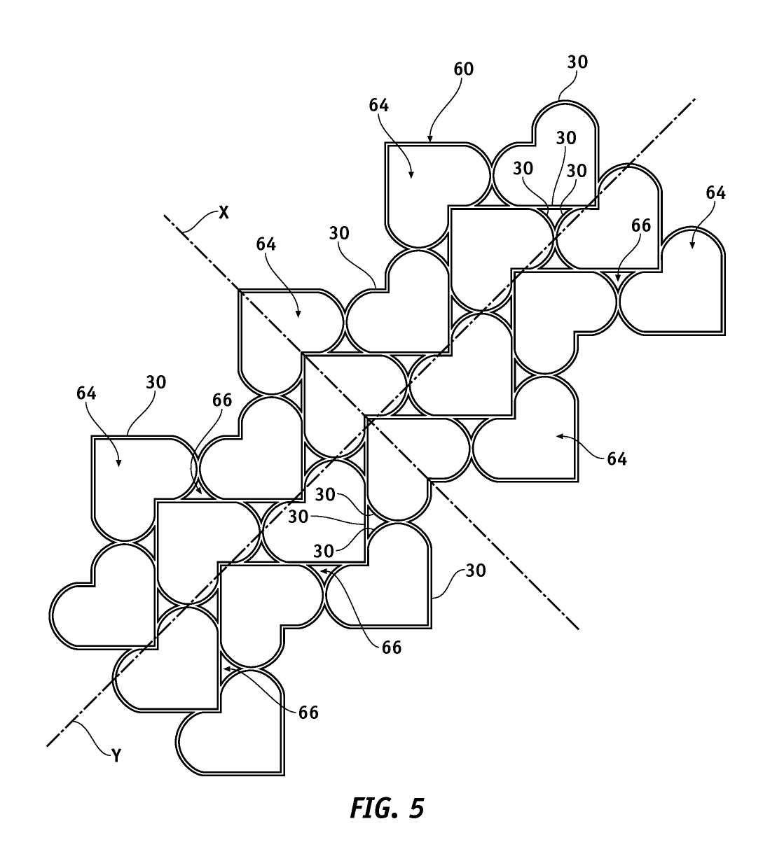

FIG. 5 is a top plan view of still another alternate embodiment of a cookie cutter 60 consisting of a framework that includes the previously-described walls 30 arranged to define a plurality of shapes, including in this embodiment shapes 64 and shapes 66. Shapes 64 and 66 are contiguous and share two or more walls 30. In this embodiment, shapes 64 and 66 are arranged in a pattern that repeats in at least two directions, including direction X and direction Y. Directions X and Y are transverse relative to each other. More specifically, directions X and Y are perpendicular relative to each other. Shapes 64 are similar to one another, meaning that they are similar in shape and similar in size. Shapes 66 are also likewise similar to one another, meaning that they are similar in shape and similar in size. Shapes 64 are different from shapes 66, both in shape and in size. In other words, shapes 64 each have a shape and a size, shapes 66 each have a shape and a size, the shape of each shape 64 is different from the shape of each shape 66, and the size of each shape 64 is different from the size of each shape 66. In this embodiment, each shape 64 is that of a heart, each shape 66 is that of a triangle with two inwardly curved sides, and the size of each shape 64 is greater than the size of each shape 66.

In accordance with the principle of the invention, the pattern of shapes 64 and 66 is that of a plane symmetry group in the nature of a two-dimensional repetitive pattern. In other words, the pattern of shapes 64 and 66 is, according to the invention, one of the known 17 plane symmetry groups that repeats in at least two directions, including the direction of axis X and the direction of axis Y in this embodiment. Moreover, the pattern of shapes 64 and 66 repeats in either direction along axis X from a center point, and in either direction along axis Y from said center point, wherein said center point is the intersection of axis X and axis Y at the geometric center of cookie cutter 60. The pattern of shapes 64 and 66 of cookie cutter 60 is plane symmetry group pm, which is a rectangle lattice made up of reflections of shapes 66 and translations of shapes 64. In cookie cutter 60 there are twenty-one shapes 64 and twenty-four shapes 66, which allows a total of forty-five cookies to be cut from cookie dough simultaneously. The repeating pattern of shapes 64 and 66 in the directions of axes X and Y allows a cookie cutter constructed and arranged according to the principle of the invention to be fashioned with less than forty-five combined shapes 64 and 66 or more than forty-five combined shapes 64 and 66 simply by repeating the pattern of shapes 64 and 66 in the directions of axes X and Y to form a cookie cutter having the desired number of shapes for simultaneously cutting a desired number of shapes from the cookie dough.

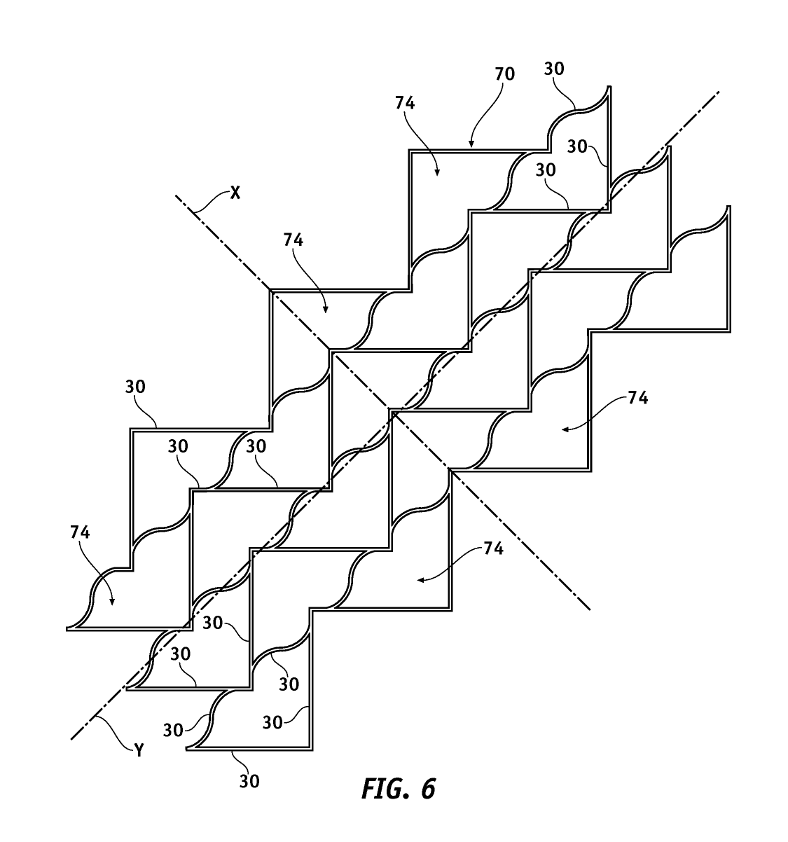

FIG. 6 is a top plan view of yet still another alternate embodiment of a cookie cutter 70 consisting of a framework that includes the previously-described walls 30 arranged to define a plurality of shapes, including in this embodiment shapes 74. Shapes 74 are contiguous and share two or more walls 30. In this embodiment, shapes 74 are arranged in a pattern that repeats in at least two directions, including direction X and direction Y. Directions X and Y are transverse relative to each other. More specifically, directions X and Y are perpendicular relative to each other. Shapes 74 are similar to one another, meaning that they are similar in shape and similar in size.

In accordance with the principle of the invention, the pattern of shapes 74 is that of a plane symmetry group in the nature of a two-dimensional repetitive pattern. In other words, the pattern of shapes 74 is, according to the invention, one of the known 17 plane symmetry groups that repeats in at least two directions, including the direction of axis X and the direction of axis Y in this embodiment. Moreover, the pattern of shapes 74 repeats in either direction along axis X from a center point, and in either direction along axis Y from said center point, wherein said center point is the intersection of axis X and axis Y at the geometric center of cookie cutter 70. The pattern of shapes 74 of cookie cutter 70 is plane symmetry group pg, which is a rectangle lattice made up of glide reflections and translations. In cookie cutter 70 there are twenty-one shapes 74, which allows a total of twenty-one cookies to be cut from cookie dough simultaneously. The repeating pattern of shapes 74 in the directions of axes X and Y allows a cookie cutter constructed and arranged according to the principle of the invention to be fashioned with less than twenty-one combined shapes 74 or more than twenty-one combined shapes 74 simply by repeating the pattern of shapes 74 in the directions of axes X and Y to form a cookie cutter having the desired number of shapes for simultaneously cutting a desired number of shapes from the cookie dough.

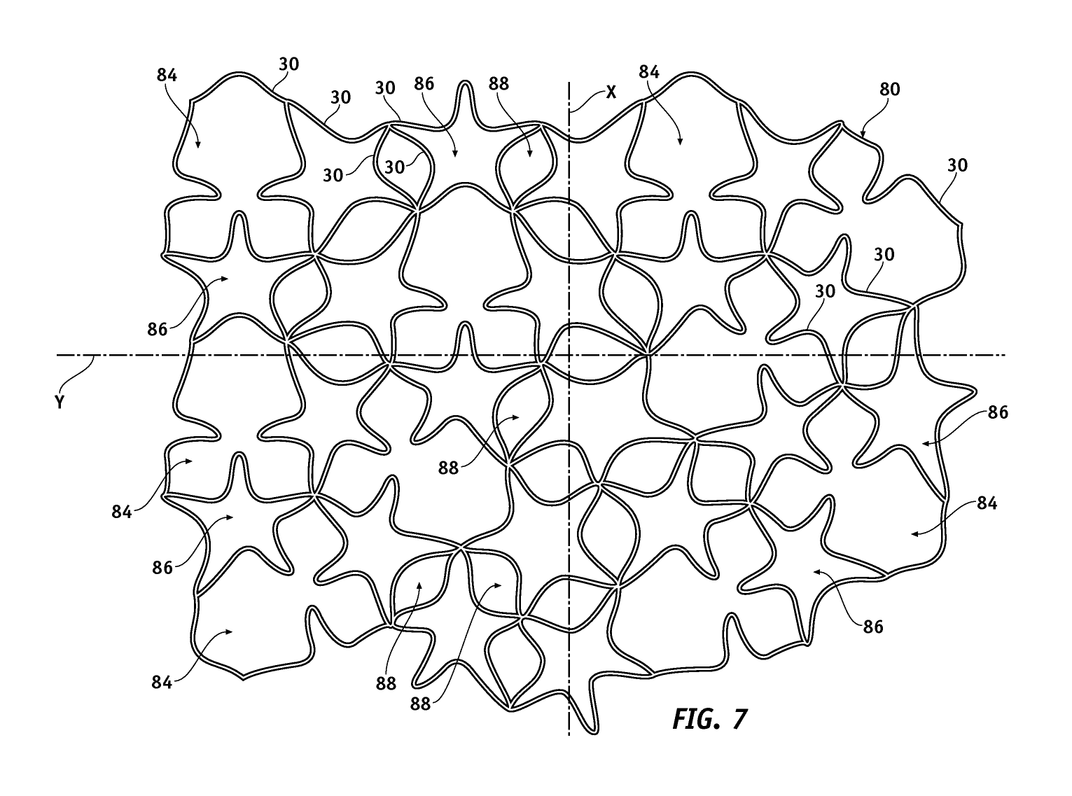

FIG. 7 is a top plan view of a further alternate embodiment of a cookie cutter 80 consisting of a framework that includes the previously-described walls 30 arranged to define a plurality of shapes, including in this embodiment shapes 84, shapes 86, and shapes 88. Shapes 84, 86, and 88 are contiguous and share two or more walls 30. In this embodiment, shapes 84, 86, and 88 are arranged in a pattern that repeats in at least two directions, including direction X and direction Y. Directions X and Y are transverse relative to each other. More specifically, directions X and Y are perpendicular relative to each other. Shapes 84 are similar to one another, meaning that they are similar in shape and similar in size. Shapes 86 are likewise similar to one another, meaning that they are similar in shape and similar in size. Shapes 88 are still likewise similar to one another, meaning that they are similar in shape and similar in size. Shapes 84, shapes 86, and shapes 88 are different from one another, both in shape and in size. In other words, shapes 84 each have a shape and a size, shapes 86 each have a different shape and a size, and shapes 88 each have still a different shape and a size. In this embodiment, each shape 84 is that of a fish, each shape 86 is that of a five-armed starfish, each shape 88 is that of a shell, and the size of each shape 84 is greater than the size of each shape 86 and each shape 88, and the size of each shape 86 is greater than the size of each shape 88.

In accordance with the principle of the invention, the pattern of shapes 84, 86, and 88 is that of a plane symmetry group in the nature of a two-dimensional repetitive pattern. In other words, the pattern of shapes 84, 86, and 88 is, according to the invention, one of the known 17 plane symmetry groups that repeats in at least two directions, including the direction of axis X and the direction of axis Y in this embodiment. Moreover, the pattern of shapes 84, 86, and 88 repeats in either direction along axis X from a center point, and in either direction along axis Y from said center point, wherein said center point is the intersection of axis X and axis Y at the geometric center of cookie cutter 80. The pattern of shapes 84, 86, and 88 of cookie cutter 80 is plane symmetry group p6m, which is a hexagon lattice made up of reflections of shapes 86 and 88, rotations of shapes 84 and shapes 88, translations of shapes 84 and 86 and 88, and glide reflections of shapes 84. In cookie cutter 80 there are ten shapes 84, twenty-one shapes 86, and eighteen shapes 88, which allows a total of forty-nine cookies to be cut from cookie dough simultaneously. The repeating pattern of shapes 84, 86, and 88 in the directions of axes X and Y allows a cookie cutter constructed and arranged according to the principle of the invention to be fashioned with less than forty-nine combined shapes 84, 86, and 88 or more than forty-nine combined shapes 84, 86, and 88 simply by repeating the pattern of shapes 84, 86, and 88 in the directions of axes X and Y to form a cookie cutter having the desired number of shapes for simultaneously cutting a desired number of shapes from the cookie dough.

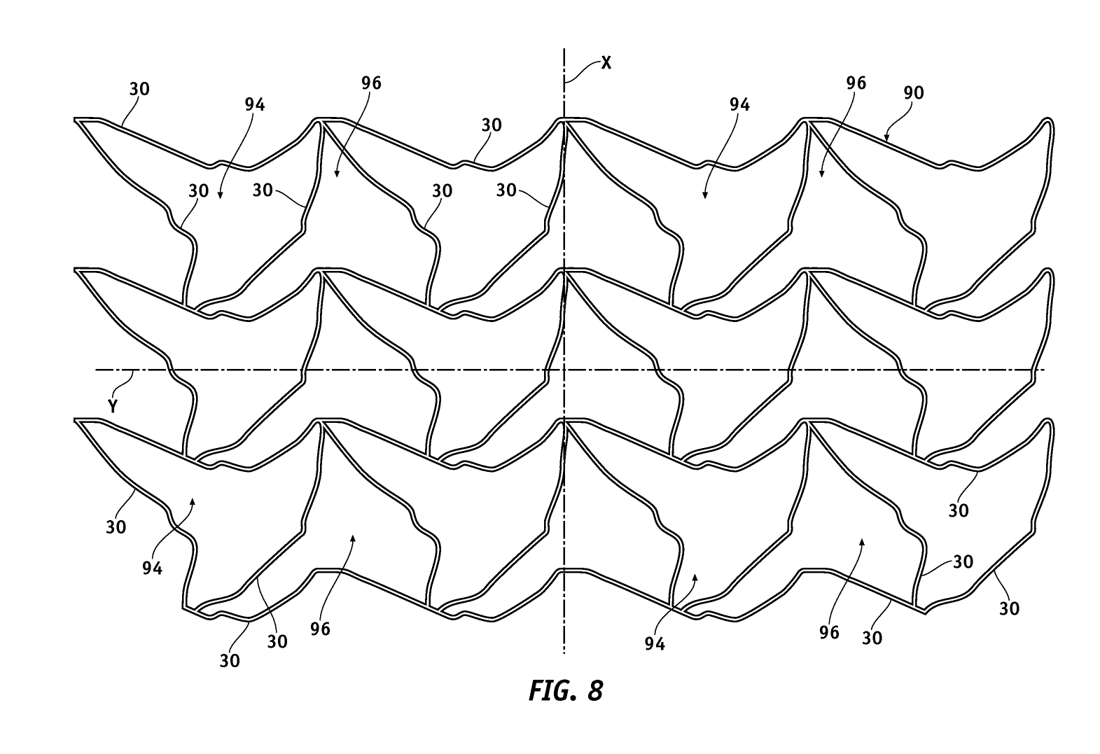

FIG. 8 is a top plan view of yet another alternate embodiment of a cookie cutter 90 consisting of a framework that includes the previously-described walls 30 arranged to define a plurality of shapes, including in this embodiment shapes 94 and shapes 96. Shapes 94 and 96 are contiguous and share two or more walls 30. In this embodiment, shapes 94 and 96 are arranged in a pattern that repeats in at least two directions, including direction X and direction

Y. Directions X and Y are transverse relative to each other. More specifically, directions X and Y are perpendicular relative to each other. Shapes 94 are similar to one another, meaning that they are similar in shape and similar in size. Shapes 96 are likewise similar to one another, meaning that they are similar in shape and similar in size. Shapes 94 are different from shapes 96, both in shape and in size. In other words, shapes 94 each have a shape and a size, shapes 96 each have a shape and a size, the shape of each shape 94 is different, albeit similar, from the shape of each shape 96, and the size of each shape 94 is different, albeit nearly the same, from the size of each shape 96. In this embodiment, each shape 94 is that of a witches hat, each shape 96 is that of a witches hat that is different but similar to that of shape 94, and the size of each shape 94 is greater, albeit somewhat, than the size of each shape 96.

In accordance with the principle of the invention, the pattern of shapes 94 and 96 is that of a plane symmetry group in the nature of a two-dimensional repetitive pattern. In other words, the pattern of shapes 94 and 96 is, according to the invention, one of the known 17 plane symmetry groups that repeats in at least two directions, including the direction of axis X and the direction of axis Y in this embodiment. Moreover, the pattern of shapes 94 and 96 repeats in either direction along axis X from a center point, and in either direction along axis Y from said center point, wherein said center point is the intersection of axis X and axis Y at the geometric center of cookie cutter 90. The pattern of shapes 94 and 96 of cookie cutter 90 is plane symmetry group p1, which is a parallelogram lattice made up of only translations of shapes 94 and translations of shapes 96. In cookie cutter 90 there are twelve shapes 94 and nine shapes 96, which allows a total of twenty-one cookies to be cut from cookie dough simultaneously. The repeating pattern of shapes 94 and 96 in the directions of axes X and Y allows a cookie cutter constructed and arranged according to the principle of the invention to be fashioned with less than twenty-one combined shapes 94 and 96 or more than twenty-one combined shapes 94 and 96 simply by repeating the pattern of shapes 94 and 96 in the directions of axes X and Y to form a cookie cutter having the desired number of shapes for simultaneously cutting a desired number of shapes from the cookie dough.

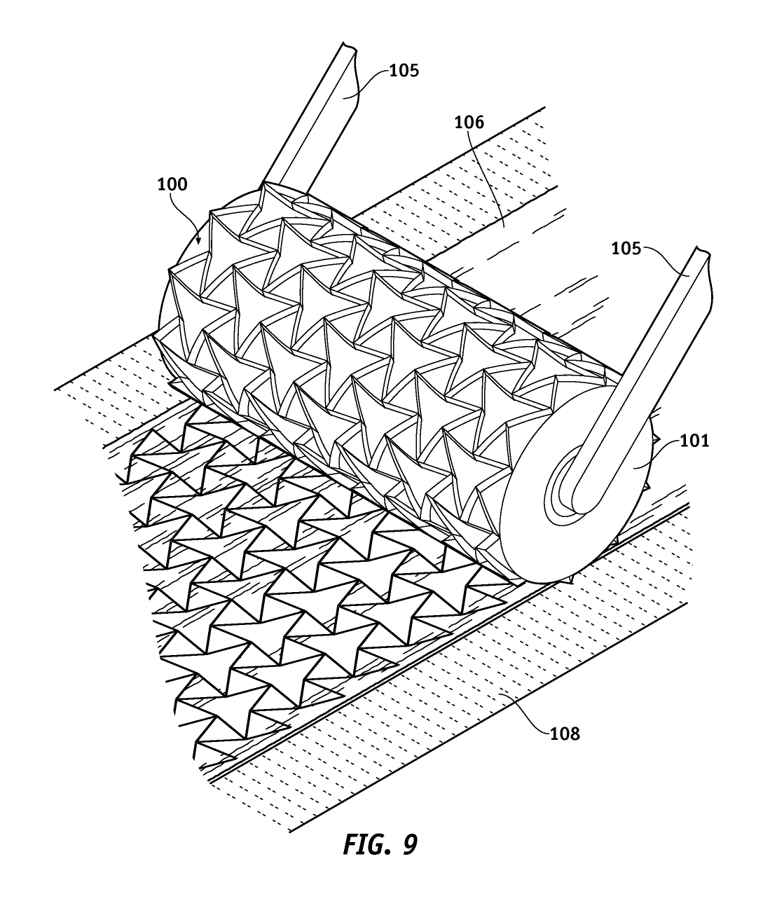

The invention has been described above with reference to preferred embodiments. However, those skilled in the art will recognize that changes and modifications may be made to the embodiments without departing from the nature and scope of the invention. For instance, any of the cookie cutter configurations illustrated in the embodiments of FIGS. 1-8 can be formed on a roller for use in cutting shapes from long sheets of cookie dough via rolling the roller across a long sheet of cookie dough. To illustrate this point, FIG. 9 illustrates the pattern of shapes 34 and 36 of cookie cutter 20 shown in FIGS. 1 and 2 formed into a continuous framework 100 applied to the outer circumference of a roller 101 mounted for rotation to a pair of opposed supports 105 for cutting shapes of cookies via rolling into a long sheet of cookie dough 106 as it is being transported by a conveyor 108. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A cookie cutter, comprising a plurality of walls arranged to define a plurality of contiguous shapes arranged in pattern that repeats in at least two directions.

2. The cookie cutter according to claim 1, wherein the shapes are similar.

3. The cookie cutter according to claim 1, wherein:
the shapes comprise first shapes and second shapes;
the first shapes are similar;
the second shapes are similar; and
the first shapes are different from the second shapes.

4. The cookie cutter according to claim 3, wherein the first shapes each have a first size, the second shapes each have a second size, and the first size of each of the first shapes is larger than the second size of each of the second shapes.

5. The cookie cutter according to claim 4, wherein the first shapes are divided.

6. The cookie cutter according to claim 5, wherein the second shapes are arranged in divided, directly adjoining clusters.

7. A cookie cutter, comprising a plurality of walls arranged to define a plurality of contiguous shapes arranged in a pattern that is symmetrical and that repeats along a first axis and a second axis, wherein the first axis is perpendicular relative to the second axis.

8. The cookie cutter according to claim 7, wherein the shapes are similar.

9. The cookie cutter according to claim 7, wherein:
the shapes comprise first shapes and second shapes;
the first shapes are similar;
the second shapes are similar; and
the first shapes are different from the second shapes.

10. The cookie cutter according to claim 9, wherein the first shapes each have a first size, the second shapes each have a second size, and the first size of each of the first shapes is larger than the second size of each of the second shapes.

11. The cookie cutter according to claim 10, wherein the first shapes are divided.

12. The cookie cutter according to claim 11, wherein the second shapes are arranged in divided, directly adjoining clusters.
